(19) United States
(12) Patent Application Publication
(10) Pub. No.: US 2023/0065362 A1
(43) Pub. Date: Mar. 2, 2023

(54) PIPELINE SUSPENSION INSPECTING GAUGE

(71) Applicants: Southern University of Science and Technology, Shenzhen (CN); WeiHai HuaTeng Offshore Engineering Technology Co., Ltd, Weihai (CN); Yichang HuaTeng Pipeline Engineering Co., Ltd, Yichang (CN)

(72) Inventors: Chuntian ZHAO, Shenzhen (CN); Hongmei LI, Yichang (CN); Xiao YANG, Shenzhen (CN); Junying LIAN, Weihai (CN)

(21) Appl. No.: 17/894,588

(22) Filed: Aug. 24, 2022

(30) Foreign Application Priority Data
Aug. 27, 2021 (CN) 202110997098.2

(51) Int. Cl. F16L 55/40; F16L 55/32

(52) U.S. Cl. CPC F16L 55/40; F16L 55/32; F16L 2101/30

(57) ABSTRACT

Disclosed is a pipeline suspension inspecting gauge which comprises a mobile carrier and a power supply module, a primary controller, a positioning module, a vibration sensor, a variable-frequency excitation device, a secondary controller, and a data processing assembly which are arranged on the mobile carrier. The power supply module, the positioning module, and the secondary controller are all electrically connected with the primary controller; the variable-frequency vibration excitation device, the vibration sensor, and the data processing assembly are all electrically connected with the secondary controller. The pipeline suspension inspecting gauge is simple in structure and high in measurement sensitivity.

### CROSS-REFERENCES TO RELATED APPLICATIONS

This application claims the priority of Chinese patent application no. 202110997098.2, filed on Aug. 27, 2021, the entire contents of all of which are incorporated herein by reference.

### FIELD OF THE UTILITY MODEL

The present utility model belongs to the field of pipeline inspection and, more particularly, to a pipeline suspension inspecting gauge.

### BACKGROUND

Subsea oil and gas pipeline are the lifeline for transporting petroleum and natural gas. Since the pipeline has a plurality of advantages including large transportation capacity, stable and reliable operation practices, high conveying efficiency with relatively low cost, and less risk induced by climate conditions, etc., the pipeline remains the best choice for subsea oil and gas transportation. However, the pipeline is subjected to various environmental actions during its lifetime, including near-seabed current erosion, seabed environmental change, and subsea topography variation, thus problems including pipeline suspension or free span may appear. When it happens, the current transverse to the pipeline will lead to vortex shedding behind the suspended part, generating a vertical excitation and vibration in a suspended section of the pipeline, that is, inducing and generating a vortex-induced vibration on the pipeline. The sustained pipeline vibration will cause the fatigue damage and corrosion, even leading to a pipeline leakage or breakage, production loss and environment pollution. Therefore, performing a regular or need-based suspension inspection for the pipeline is critical to maintain a safe operation of the pipeline and a basic requirement for integrity management.

A suspension inspection of a pipeline mainly comprises inspecting the state of the pipeline suspension (whether suspension occurs or not) and determining the length of a free-span. A widely applied inspection method for a pipeline suspension in the prior art is still using the routing inspection, that is, performing a patrol inspection with methods along a pipeline including visual examining, touching exploring, ultrasonic imaging and more, via underwater manpower (limited in shallow water) or an underwater vehicle (a ROV, Remote Operated Vehicle). In a newly developed method, a set of equipment carried by a ROV includes underwater camera, side scan sonar and more is utilized, which still belongs to the category of the most basic, most original, most commonly used routing inspection. All such inspection methods require a vessel at least, and further require a large amount of personnel and support equipment, and more. Therefore, this kind of conventional inspection method may not able to be arranged in time when suddenly required, instead, it is often needed to take a plurality of factors into account, including personnel, equipment, and the available period of supporting ship, weather condition, sea condition, operation preparation work and plan, and more, especially after a storm or typhoon, it is impossible to complete an inspection quickly before re-start, which may affect the production. Considering the disadvantages including high cost, long consumed time, low efficiency, high personnel risk, and even being impossible to implement timely, this industry requires more convenient, more efficient and more economical suspension inspection technology and method for subsea pipeline.

Therefore, the prior art needs to be improved and developed.

### BRIEF SUMMARY OF THE DISCLOSURE

To solve the technical problem stated above, the present invention provides a pipeline suspension inspecting gauge, capable of generating a frequency -adjustable transverse vibration excitation, locating and detecting the suspension, and evaluating free-span length via monitoring the vibration responses of the pipeline.

To achieve the object stated above, the technical solution of the present invention includes:

A pipeline suspension inspecting gauge, which comprises a mobile carrier, a power supply module, a primary controller, a positioning module, a set of vibration sensors, a variable-frequency excitation device, a secondary controller, and a data processing assembly arranged in the mobile carrier, wherein the power supply module, the positioning module, and the secondary controller are all connected with the primary controller electrically, the variable-frequency excitation device, the vibration sensor, and the data processing assembly are all connected with the secondary controller electrically, while the positioning module is configured to position a geographic space position of the mobile carrier, the variable-frequency excitation device is configured to generate a transverse vibration excitation to the pipeline, the vibration sensors are configured to monitor the vibration responses generated by the pipeline under the transverse vibration excitation and by the movement of the gauge or the mobile carrier, and the data processing assembly is configured to process and analyze the vibration responses detected by the vibration sensors.

The technical solution stated above has a beneficial effect that: in such a way, a pipeline gauge can be sent into the pipeline through a launcher, and the pipeline gauge moves forward with the fluid in the pipeline, generating a transverse vibration excitation to the pipeline by the variable-frequency excitation device, the vibration excitation is passed onto the pipeline through a contact point on pipe wall, and its motion response signals are collected via the vibration sensors, and the response data are processed by the data processing assembly, to judge whether the current pipe location is in a suspended state or not, the vibration responses are analyzed, that is, check if the vibration responses are large enough, meeting the suspension criteria, and meanwhile, by combining the positioning information provided by the positioning module, a suspension-distribution along the pipeline and a free-span length are obtained.

In the technical solution stated above, the mobile carrier comprises a driving cup, a supporting disc, and a main body with an internal cabin, the power supply module, the primary controller, the variable-frequency excitation device, the secondary controller, and the data processing assembly are all arranged inside the main body, the driving cup is coaxially installed at the front end of the main body, and the supporting disc is coaxially installed at the rear end of the main body.

The technical solution stated above has a beneficial effect that: in such a way, the mobile carrier is able to be driven by the fluid to move forward in the pipeline, keeping a state thereof stable when moving forward.

In the technical solution stated above, the variable-frequency excitation device comprises a driving member and an excitation actuator, the excitation actuator and the driving member are both arranged in the main body, the driving member is electrically connected to the secondary controller, and the driving member is configured to drive the excitation actuator to operate to generate the transverse vibration excitation.

The technical solution stated above has a beneficial effect that: in such a way, the driving member drives the excitation actuator to generate the transverse vibration excitation required.

In the technical solution stated above, the driving member is a variable-frequency motor, and the excitation actuator is a crank reciprocating mechanism or an eccentric wheel arranged at a driving end of the driving member.

The technical solution stated above has a beneficial effect that: in such a way, the variable-frequency motor is configured to drive the crank reciprocating mechanism to reciprocate and generate a transverse vibration excitation, or the variable-frequency motor is configured to drive the eccentric wheel to rotate and generate a transverse vibration excitation.

In the technical solution stated above, the variable-frequency excitation device is an electromagnetic hammer or an electromagnetic exciter.

The technical solution stated above has a beneficial effect that: in such a way, a principle of an electromagnetic driving can be configured to generate the transverse vibration excitation.

In the technical solution stated above, the positioning module is a gyroscope installed in the main body and/or a mileage wheel arranged outside the main body and configured to contact with an inner wall of the pipeline in rolling.

The technical solution stated above has a beneficial effect that: in such a way, the solution has a good positioning effect and a high positioning accuracy.

In the technical solution stated above, the mobile carrier further comprises at least two groups of rolling assemblies, a plurality of groups of the rolling assemblies are arranged on the main body at an interval in a front-rear direction, the plurality of groups of the rolling assemblies are configured to contact with the inner wall of the pipeline when rolling, and transmitting the transverse vibration excitation to the pipeline; and a vibration sensor is arranged on the rolling assembly and configured to monitor the vibration responses generated by the pipeline.

The technical solution stated above has a beneficial effect that: in such a way, the mobile carrier is supported in the pipeline by two groups of the rolling assemblies, making the mobile carrier move more stably in the pipeline.

In the technical solution stated above, the rolling assembly comprises a plurality of rolling members, the plurality of rolling members are arranged on the outer side of the main body with the same interval to each other in the circumferential direction, each rolling member is contacting with the inner wall of the pipeline in rolling, as arranged, the plurality of vibration sensors are corresponding to the plurality of rolling members one by one, and each vibration sensor is arranged on a corresponding rolling member.

The technical solution stated above has a beneficial effect that: in such a way, a stability of the mobile carrier is better when moving in the pipeline, and the transverse vibration excitation generated by the variable-frequency excitation device can be transmitted to the pipeline through the rolling member, and in addition, the vibration responses of the pipeline are transmitted to the vibration sensors fixedly installed on the pipeline through the rolling members.

In the technical solution stated above, the rolling member comprises an elastic damping member, a roller, and a wheel holder, the elastic damping member is fixedly arranged on the outer side of the main body, a damping end of the elastic damping member faces away from the main body, the roller is arranged at the damping end of the elastic damping member correspondingly through the wheel holder, and the vibration sensor is arranged on the wheel holder of the rolling member.

The technical solution stated above has a beneficial effect that: in such a way, a passage capacity of the mobile carrier in the pipeline is better, the roller can be kept in contact with the pipeline, and when encountering an obstacle, the elastic damping member can be extruded to contract, so as to pass through the obstacle.

In the technical solution stated above, the elastic damping member comprises a sleeve, a second spring, and a rod body, one end of the sleeve is open, one end of the rod body extends into the sleeve, and the end inside the sleeve has an outer flange, an opening end of the sleeve has an inner flange configured to restrict the rod body from sliding out of the sleeve; the second spring is arranged inside the sleeve, one end of the second spring abuts against a bottom wall inside the sleeve, another end of the second spring abuts against the end of the rod body inside the sleeve, an elastic tension of the second spring is configured to drive the rod body to move to the bottom wall of the sleeve, an end of the rod body outside the sleeve constitutes a damping end of the elastic damping member, and an end of the sleeve facing away from the opening end thereof is connected fixedly to the main body.

The technical solution stated above has a beneficial effect that: a structure thereof is simple and having a good damping performance, the rod body, when being squeezed by an external force, will shrink into the sleeve, and after the external force is withdrawn, the rod body will move to reset under an action of the second spring.

### BRIEF DESCRIPTION OF THE DRAWINGS

FIG. 1 illustrates a schematic structural diagram of a pipeline suspension inspecting gauge according to an embodiment of the present invention;

FIG. 2 illustrates a matching diagram of a rolling assembly of the pipeline suspension inspecting gauge and a pipeline according to an embodiment of the present invention;

FIG. 3 illustrates a schematic structural diagram of an elastic damping member according to an embodiment of the present invention;

FIG. 4 illustrates a connection diagram of an electrical module of the pipeline suspension inspecting gauge according to an embodiment of the present invention.

1-mobile carrier; 11-main body; 12-driving cup; 13-supporting disc; 141-rolling member; 1411-elastic damping member; 1412-roller; 1413-wheel holder; 14111-sleeve; 14112-second spring; 14113-rod body; 21-rechargeable battery; 22-power supply management unit; 3-primary controller; 4-positioning module; 5-vibration sensor; 6-variable-frequency excitation device; 61-driving member; 62-excitation actuator; 7-secondary controller; 8-data processing assembly; 9-pipeline.

### DETAILED DESCRIPTION

The principle and feature of the present invention are described below with reference to the accompanying drawings, a plurality of embodiments are provided for explaining the present invention merely, instead of intending to limit the scope of the present invention. The present invention is described in more detail by way of example with reference to a plurality of accompanying drawings in the following paragraphs. The advantages and features of the present invention will become more apparent from the following description and claims. It should be noted that, the accompanying drawings are all in a very simplified form and in an inaccurate scale, which are used to facilitate and clearly assist the purpose of explaining the embodiments of the present invention only.

Unless otherwise defined, all technical and scientific terms used herein have a same meaning as commonly understood by one of ordinary skill in the art to which this invention belongs. The terms used herein in the description of the present invention are for a purpose of describing a specific embodiment only, instead of intending to limit the present invention. As used herein, the term “and/or” includes any and all combinations of one or more of the items listed and associated.

It should be noted that when an element is referred to as being “fixed to” another element, it can be directly on the other element or an intervening element may also be present. When an element is referred to as being “connected” to another element, it can be directly connected to the other element or an intervening element may also be present. The terms “vertical”, “horizontal”, “left”, “right” and similar expressions used herein are for the purpose of illustration only and do not represent an only embodiment.

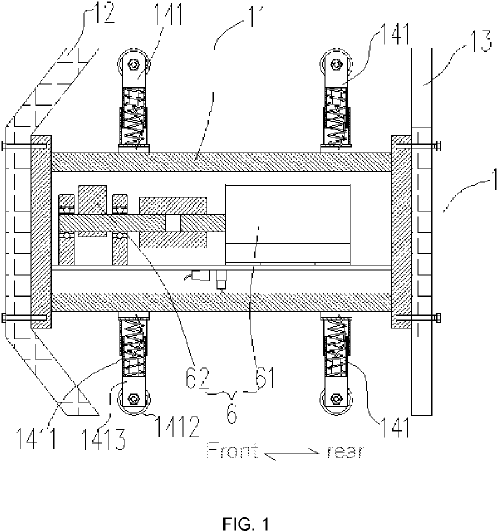

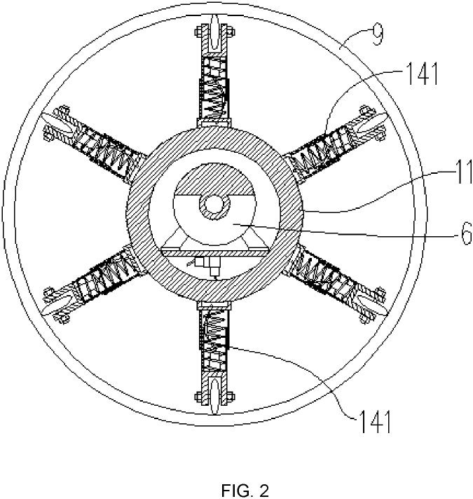

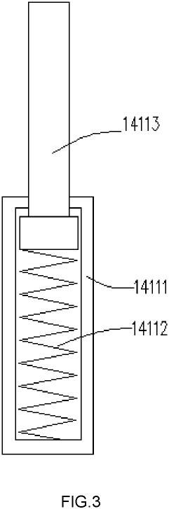

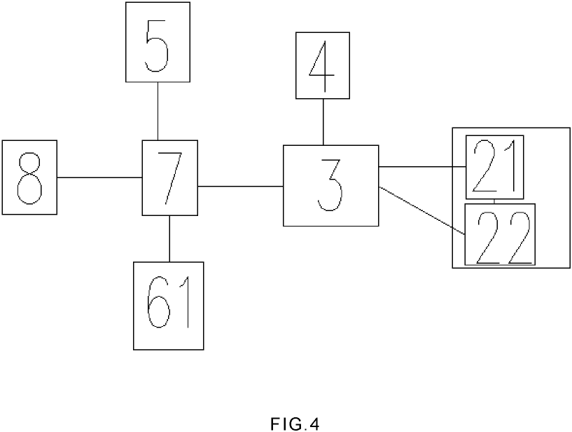

As shown in FIGS. 1 to FIGS. 4, the present embodiment provides a pipeline suspension inspecting gauge, which comprises a mobile carrier 1 and a power supply module, a primary controller 3, a positioning module 4, a vibration sensor 5, a variable-frequency excitation device 6, a secondary controller 7, and a data processing assembly 8 arranged on the mobile carrier 1. The power supply module, the positioning module 4, and the secondary controller 7 are all connected to the primary controller 3 electrically. The variable-frequency excitation device 6, the vibration sensor 5 and the data processing assembly 8 are all connected with the secondary controller 7 electrically. The positioning module 4 is configured to position a geographical space position of the mobile carrier 1. The vibration sensor 5 is configured to monitor a vibration response generated by the pipeline 9 under the transverse vibration excitation or by the movement of the gauge or the mobile carrier 1. The data processing assembly 8 is configured to process and analyze the vibration response detected by the vibration sensor 5. In such a way, the pipeline inspecting gauge can be sent into the pipeline 9 through a launcher, and the pipeline inspecting gauge in the pipeline 9 moves forward with the fluid in the pipeline 9, generating a transverse vibration excitation on the pipeline 9 by the variable-frequency excitation device 6 capable of changing a vibration frequency, the vibration excitation is passed onto the pipeline 9 through a contact point on the pipeline wall, and its motion response signals are collected via the vibration sensor 5, and the response data are processed by the data processing assembly 8, to judge whether a current position of the pipeline 9 is in a suspended state or not, the vibration responses are analyzed, that is, check if the vibration responses are large enough, meeting a suspension criteria. Meanwhile, by combining a positioning information provided by the positioning module 4, a suspension distribution along the pipeline 9 and a free-span length are obtained. The primary controller, the secondary controller, and the data processing assembly may all refer to a primary controller, a secondary controller, and a second data processing assembly disclosed in “a pipeline inspecting gauge” as disclosed in patent No. CN111649192A. Therefore, details are not described herein again.

In the technical solution stated above, the mobile carrier 1 comprises a driving cup 12, a supporting disc 13, and a main body 11 with an internal cabin, the power supply module, the primary controller 3, the variable-frequency excitation device 6, the secondary controller 7 and the data processing assembly 8 are all arranged inside the main body 11, the driving cup 12 is coaxially and fixedly installed at a front end of the main body 11, and the supporting disc 13 is coaxially and fixedly installed at a rear end of the main body 11. In such a way, the mobile carrier 1 is able to be driven by the fluid to move forward in the pipeline 9, and keeping a state thereof stable when moving forward.

In the technical solution stated above, the variable-frequency excitation device 6 comprises a driving member 61 and an excitation actuator 62, the excitation actuator 62 and the driving member 61 are both arranged in the main body 11, the driving member 61 is electrically connected to the secondary controller 7, and the driving member 61 is configured to drive the excitation actuator 62 to operate before generating a transverse vibration excitation. In such a way, the driving member 61 drives the excitation actuator 62 to generate the transverse vibration excitation required.

In the technical solution stated above, the driving member 61 is a variable-frequency motor, and the excitation actuator 62 is a crank reciprocating mechanism or an eccentric wheel arranged at a driving end of the driving member 61. In such a way, the variable-frequency motor is configured to drive the crank reciprocating mechanism to reciprocate and generate a transverse vibration excitation, or the variable-frequency motor is configured to drive the eccentric wheel to rotate and generate a transverse vibration excitation.

In the technical solution stated above, the variable-frequency excitation device 6 is an electromagnetic hammer or an electromagnetic exciter. In such a way, a principle of an electromagnetic driving can be configured to generate the transverse vibration excitation.

In the technical solution stated above, the positioning module 4 is a gyroscope installed in the main body 11 and/or a mileage wheel arranged outside the main body 11 and configured to contact with an inner wall of the pipeline 9 in rolling. In such a way, a positioning effect is good, and a positioning precision is high.

In the technical solution stated above, the mobile carrier 1 further comprises at least two groups of rolling assemblies, a plurality of groups of the rolling assemblies are arranged on the main body 11 at an interval in a front-rear direction, the plurality of groups of the rolling assemblies are configured to contact with the inner wall of the pipeline 9 in rolling, and transmit the transverse vibration excitation to the pipeline 9; and the vibration sensor 5 is arranged on the rolling assembly and configured to monitor a vibration response made by the pipeline. In such a way, the mobile carrier 1 is supported in the pipeline 9 by two groups of the rolling assemblies, making the mobile carrier 1 move more stably in the pipeline 9.

In the technical solution stated above, the rolling assembly comprises a plurality of rolling members 141, the plurality of rolling members 141 are arranged on an outer side of the main body 11 at an interval following a circle, each rolling member 141 is contacting with the inner wall of the pipeline 9 in rolling, the vibration sensors 5 are arranged in a plurality, the plurality of vibration sensors 5 are corresponding to the plurality of rolling members 141 one by one, and each vibration sensor 5 is arranged on a corresponding rolling member 141. In such a way, a stability of the mobile carrier 1 is better when moving in the pipeline 9, and the transverse vibration excitation generated by the variable-frequency excitation device 6 can be transmitted to the pipeline 9 through the rolling member 141, and in addition, the vibration response of the pipeline 9 is transmitted to the vibration sensor 5 fixedly installed on the pipeline 9 through the rolling member 141.

In the technical solution stated above, the rolling member 141 comprises an elastic damping member 1411, a roller 1412, and a wheel holder 1413, the elastic damping member 1411 is fixedly arranged on the outer side of the main body 11, a damping end of the elastic damping member 1411 faces away from the main body 11, the roller 1412 is arranged at a damping end of the elastic damping member 1411 correspondingly through the wheel holder 1413, and the vibration sensor 5 is arranged on the wheel holder 1413 of the rolling member 141. In such a way, a passage capacity of the mobile carrier 1 in the pipeline 9 is better, the roller 1412 can be kept in contact with the pipeline 9, and when encountering an obstacle, the roller 1412 can extrude the elastic damping member 1411 to contract, so as to pass through the obstacle.

In the technical solution stated above, the elastic damping member 1411 comprises a sleeve 14111, a second spring 14112, and a rod body 14113, one end of the sleeve 14111 is open, one end of the rod body 144113 extends into the sleeve 14111, and the end inside the sleeve 14111 has an outer flange, an opening end of the sleeve 14111 has an inner flange configured to restrict the rod body 14113 from sliding out of the sleeve 14111; the second spring 14112 is arranged inside the sleeve 14111, one end of the second spring 14112 abuts against a bottom wall inside the sleeve 14111, another end of the second spring 14112 is abutting against the end of the rod body 14113 inside the sleeve 14111, an elastic tension of the second spring 14112 is configured to drive the rod body 14113 to the bottom wall of the sleeve 14111, an end of the rod body 14113 outside the sleeve 14111 constitutes a damping end of the elastic damping member 1411, and an end of the sleeve 14111 facing away from the opening end thereof is connected and fixing to the main body 11. A structure thereof is simple and having a good damping performance, the rod body 14113, when being squeezed by an external force, will shrink into the sleeve 14111, and after the external force is withdrawn, the rod body 14113 will be recovered under an action of the second spring 14112.

In the technical solution stated above, the power supply module comprises a rechargeable battery 21, to provide a reusable power required by gauge, which is beneficial to reduce a cost.

In the technical solution stated above, the power module further comprises a power supply management unit 22 (which belongs to the prior art and will not be repeated herein), and the power supply management unit 22 connects to the rechargeable battery 21 and the primary controller 3 electrically and respectively, configured to monitor a remaining power of the rechargeable battery 21, facilitate grasping a remaining power information of the rechargeable battery 21 in real time.

It should be understood that, the application of the present utility model is not limited to the examples listed above. It will be possible for the skilled in the art to make modification or replacements according to the above descriptions, which shall all fall within the scope of protection in the appended claims of the present application.

What is claimed is:

1. A pipeline suspension inspecting gauge, arranged in a pipeline (9) for transporting a fluid, wherein comprising a mobile carrier (1) and a power supply module, a primary controller (3), a positioning module (4), a vibration sensor (5), a variable-frequency excitation device (6), a secondary controller (7), and a data processing assembly (8) arranged on the mobile carrier (1), the power supply module, the positioning module (4), and the secondary controller (7) are all connected with the primary controller (3) electrically, the variable-frequency excitation device (6), the vibration sensor (5), and the data processing assembly (8) are all connected with the secondary controller (7) electrically, while the positioning module (4) is configured to locate a geographic space position of the mobile carrier (1), the variable-frequency excitation device (6) is configured to generate a transverse vibration excitation in the pipeline (9), the vibration sensor (5) is configured to monitor vibration responses generated by the pipeline (9) under the transverse vibration excitation and a movement of the gauge or the mobile carrier (1), the data processing assembly (8) is configured to process and analyze the vibration responses detected by the vibration sensor (5).

2. The pipeline suspension inspecting gauge according to claim 1, wherein the mobile carrier (1) comprises a driving cup (12), a supporting disc (13), and a main body (11) with an internal cabin, the power supply module, the primary controller (3), the variable-frequency excitation device (6), the secondary controller (7), and the data processing assembly (8) are all arranged inside the main body (11), the driving cup (12) is coaxially and fixedly installed at a front end of the main body (11), and the supporting disc (13) is coaxially and fixedly installed at a rear end of the main body (11).

3. The pipeline suspension inspecting gauge according to claim 2, wherein the variable-frequency excitation device (6) comprises a driving member (61) and an excitation actuator (62), the excitation actuator (62) and the driving member (61) are both arranged in the main body (11), the driving member (61) is electrically connected to the secondary controller (7), and the driving member (61) is configured to drive the excitation actuator (62) to operate to generate the transverse vibration excitation.

4. The pipeline suspension inspecting gauge according to claim 3, wherein the driving member (61) is a variable-frequency motor, and the excitation actuator (62) is a crank reciprocating mechanism or an eccentric wheel arranged at a driving end of the driving member (61).

5. The pipeline suspension inspecting gauge according to claim 2, wherein the variable-frequency excitation device (6) is an electromagnetic hammer or an electromagnetic exciter.

6. The pipeline suspension inspecting gauge according to claim 2, wherein the positioning module (4) is a gyroscope installed in the main body (11) and/or a mileage wheel arranged outside the main body (11) to contact with an inner wall of the pipeline (9) in rolling.

7. The pipeline suspension inspecting gauge according to claim 2, wherein the mobile carrier (1) further comprises at least two groups of rolling assemblies, a plurality of groups of the rolling assemblies are arranged on the main body (11) at an interval in a front-rear direction, the plurality of groups of the rolling assemblies are configured to contact with an inner wall of the pipeline (9) in rolling, and transmit the transverse vibration excitation to the pipeline (9); and the vibration sensor (5) is arranged on the rolling assembly and configured to monitor the vibration responses generated by the pipeline (9).

8. The pipeline suspension inspecting gauge according to claim 7, wherein the rolling assembly comprises a plurality of rolling members (141), the plurality of rolling members (141) are arranged on an outer side of the main body (11) with an interval to each other in a circumferential direction, each of the rolling members (141) is contacted with the inner wall of the pipeline (9) in rolling, a plurality of the vibration sensors (5) are arranged, the plurality of vibration sensors (5) are corresponded to the plurality of rolling members (141) one by one, and each vibration sensor (5) is arranged on a corresponding rolling member (141).

9. The pipeline suspension inspecting gauge according to claim 8, wherein the rolling member (141) comprises an elastic damping member (1411), a roller (1412), and a wheel holder (1413), the elastic damping member (1411) is fixedly arranged on the outer side of the main body (11), a damping end of the elastic damping member (1411) faces away from the main body (11), the roller (1412) is arranged at the damping end of the elastic damping member (1411) correspondingly through the wheel holder (1413), and the vibration sensor (5) is arranged on the wheel holder (1413) of the rolling member (141).

10. The pipeline suspension inspecting gauge according to claim 9, wherein the elastic damping member (1411) comprises a sleeve (14111), a second spring (14112), and a rod body (14113), the sleeve (14111) has an opening end, one end of the rod body (144113) extends into the sleeve (14111), and the end inside the sleeve (14111) has an outer flange, the opening end of the sleeve (14111) has an inner flange configured to restrict the rod body (14113) from sliding out of the sleeve (14111); the second spring (14112) is arranged inside the sleeve (14111), one end of the second spring (14112) abuts against a bottom wall inside the sleeve (14111), another end of the second spring (14112) abuts against the end of the rod body (14113) inside the sleeve (14111), an elastic tension of the second spring (14112) is configured to drive the rod body (14113) to intend to move to the bottom wall of the sleeve (14111), an end of the rod body (14113) outside the sleeve (14111) constitutes a damping end of the elastic damping member (1411), and an end of the sleeve (14111) facing away from the opening end is connected fixedly to the main body (11).
